(19) United States
(12) Patent Application Publication
(10) Pub. No.: US 2023/0245137 A1
(43) Pub. Date: Aug. 3, 2023

(54) BLOCKCHAIN SYSTEMS AND METHODS FOR PROTECTING BRANDS, OPERATORS AND CONSUMERS AGAINST COUNTERFEITING

(71) Applicant: Akerna Corporation, Denver, CO (US)

(72) Inventors: David R. McCullough, Denver, CO (US); Jessica L. Billingsley, Denver, CO (US); Thomas S. Marchi, Eatontown, NJ (US)

(21) Appl. No.: 17/590,430

(22) Filed: Feb. 1, 2022

(51) Int. Cl. G06Q 30/00; G06K 19/06

(52) U.S. Cl. CPC G06Q 30/0185; G06K 19/06131; G06Q 2220/00

(57) ABSTRACT

Each item's packaging label displays a scannable code, such as a Quick Response (QR) code, into which a nonfungible token (NFT) associated with the item has been encoded. A handheld device can be used to scan the scannable code, convert it into a data signal, extract the NFT from the data signal, process the NFT to obtain a unique identification (ID) of the item, and forward the unique II) to the blockchain network. The blockchain network processes the unique ID to authenticate the item, retrieves the data that was used to create the NFT from memory if authentication is successful, and forwards the retrieved data to the handheld device. The handheld device receives the forwarded data, processes it and causes it to be displayed on the display device of the handheld device to show the user that the item has been successfully authenticated by the blockchain network.

### TECHNICAL FIELD

The present disclosure relates to blockchain systems and methods for protecting brands, operators and consumers against counterfeiting of products.

### BACKGROUND

Blockchain technology uses a distributed ledger system in which the data associated with transactions is cryptographically encoded and stored as blocks in the ledger. In the distributed ledger, the blocks are cryptographically linked to one another to form a “chain” in such a way that data stored in the ledger is virtually impossible to delete or modify. The ledger is “distributed” in that every node on the blockchain network has a copy of the ledger and receives a copy of the updated ledger anytime a new transaction on the blockchain is performed and the corresponding cryptographically-encoded data is added as a block on the chain.

Each user, i.e., node, on the network has a private key and a public key. The public keys are used by the nodes on the network to identify and communicate with one another, whereas each user's private key, which is not known to the other users of the network, is needed to perform transactions. The public and private keys are used in cryptographic hashing algorithms to perform transactions that result in the cryptographically-encoded blocks being added to the chain once they have been validated. In general, when a user requests a transaction on the network, a cryptographically-encoded block is created and broadcast to all of the nodes on the network. Nodes of the network have processors that perform a consensus algorithm that processes the block to validate it. Once the block is validated, it is added to the ledger and the updated ledger is broadcast to all the nodes of the network.

Blockchain networks vary depending on the type of blockchain technology used, but they all have the above attributes in common. Because it is virtually impossible to delete or modify data stored in the blockchain, blockchain networks are well suited for use in performing a variety of business transactions and for transacting cryptocurrency. In cryptocurrency blockchain networks, fungible tokens (FTs) represent the currency that is transacted, whereas in other types of blockchain networks, non-fungible tokens (NFTs) are used to represent non-fungible items, such as collectible items (e.g., baseball cards, art work, etc.), which can often be purchased on the network using cryptocurrency. FTs and NFTs are cryptographically-encrypted, and transactions that involve them become cryptographically-encrypted blocks of the distributed ledger.

Although the cryptographic linking attributes of blockchain networks and the distributed nature of the ledger make it virtually impossible to modify/delete data that becomes part of the blockchain, it is still possible in some cases to counterfeit NFTs or to attach an authentic NFT to packaging of a counterfeit item, which can result in harm to the consumer, the operator (i.e., the manufacturer and/or authorized distributor) and/or to the brand used in connection with the authentic item. Counterfeiting of brands is an epidemic in many industries due to large amounts of money spent in illicit markets. Counterfeit brands degrade brand reputation and can diminish brand value, resulting in risks to brand licensing revenues. Purchasing inauthentic products and selling them in illicit markets is also a liability to operators or owners of the authentic brands. In addition, the purchase by consumers of substandard and/or unsafe counterfeit products can not only endanger consumers, but can cause harm to businesses having authentic brands. Consuming counterfeit products can also be harmful due to lack of regulation and testing standards, as demonstrated by recent vaping crises, for example.

Accordingly, a need exists for a blockchain system and method that better protect consumers, brands and operators against counterfeiting of items.

### SUMMARY

The present disclosure is directed to systems and methods for using a blockchain network to protect items from being counterfeited.

In accordance with an embodiment of the method performed by the blockchain system, the method comprises:
for an item to be protected using the blockchain network:
generating a nonfungible token (NFT) for the item by performing one or more encryption algorithms that encrypt preselected data that identifies and characterizes the item;
linking the NFT to a ledger of the blockchain network; and
encoding the NFT into a scannable code to be disposed on a packaging label of a package or container that will be used to package or contain the item, the scannable code being a preselected code that can be scanned and decoded using a scanning device.

In accordance with an embodiment, the method, further comprises disposing the scannable code having the NFT encoded therein on the packaging label.

In accordance with an embodiment, the method further comprises disposing the packaging label on the package or container.

In accordance with an embodiment, the item comprises at least one of something that was grown, something that was raised, something that was manufactured and something that was created.

For cases in which the item was grown, and the preselected data that is used to generate the NFT for the item comprises at least one of (1) information identifying what the item is, (2) information identifying a particular farm where the item was grown, (3) a date that the item was harvested, (4) any brand associated with the item, information identifying a batch to which the item belongs, (5) information identifying a party or association that grew the batch, (6) information identifying any certifications associated with the item, (7) information identifying any tests that have been performed on the item or on the corresponding batch, and (8) any test results associated with testing of the item or the corresponding batch.

For cases in which the item was manufactured or created, the preselected data that is used to generate the NFT comprises at least one of (1) information identifying what the item is, (2) information identifying the manufacturer or creator, (3) information identifying the manufacturing facility, (4) information identifying a batch to which the item belongs, (5) information identifying a part number, model number or name for the item, (6) information identifying a style of the item, (7) any brand name associated with the item, (8) information identifying any certifications associated with the item, (9) information identifying any tests that have been performed on the item or the batch, (10) information identifying any testing results associated with testing of the item or the corresponding batch.

In accordance with an embodiment, generating the NFT comprises:
(1) formatting said preselected data into a structured data object;
(2) processing the formatted data object with a cryptographic hashing algorithm to compute a checksum;
(3) signing the checksum with a private key associated with an original owner of the item to compute a signature;
(4) appending the computed signature to the structured data object to produce the NFT;
(5) performing a compression algorithm that compresses the NFT; and
(6) storing the compressed NFT in a memory device of the blockchain network.

In accordance with an embodiment, generating the NFT further comprises:
(7) using the NFT produced at step (4) to generate a unique Uniform Resource Locator (URL) for the item; and
(8) modifying the unique URL by concatenating the computed signature to unique URL to create a unique identifier (ID) for the item.

In accordance with an embodiment, a handheld device performs a method for authenticating an item using a blockchain network. The method comprises:
with a handheld device:
   scanning a scannable code disposed on a packaging label of an item to be authenticated using the blockchain network and producing a data signal representing the scannable code;
   in one or more processors of the handheld device:
   decoding the data signal representing the scannable code into a decoded data signal, the decoded data signal comprising a nonfungible token (NFT) associated with the item, the NFT being linked to the blockchain network;
   processing the decoded data signal to extract the NFT;
   processing the extracted NFT to obtain a unique identification (ID) associated with the item from the NFT;
   forwarding the unique ID in an authentication request to one or more processors of the blockchain network to be processed by said one or more processors of the blockchain network to validate the item associated with the NFT;
   if the said one or more processors of the blockchain network is able to authenticate, receiving an acknowledgement from the blockchain network that the item is authentic along with preselected data that was used to generate the NFT; and
   displaying an indication on a display device of the handheld device that the item has been authenticated along with the preselected data.

In accordance with an embodiment of the method performed by the blockchain network: receiving an authentication request from a handheld device, the authentication request comprising a unique identifier (ID) obtained from a nonfungible token (NFT) that was embedded in a scannable code disposed on a packaging label of a package or container for the item
processing the unique ID to determine whether or not the item is authentic;
if a determination is made that the item is authentic, retrieving preselected data that was used to create the NFT from one or more memory devices and forwarding the preselected data that was used to create the NFT to the handheld device.

In accordance with an embodiment of the blockchain system for using a blockchain network to protect items from being counterfeited, the system comprises:
a memory device; and
one or more processors configured to perform one or more blockchain algorithms that:
   generate a nonfungible token (NFT) for each item by performing one or more encryption algorithms that encrypt preselected data that identifies and characterizes the item;
   link the NFT to a ledger of the blockchain network; and
   encode the NFT into a scannable code to be disposed on a packaging label of a package or container that will be used to package or contain the item, the scannable code being a preselected code that can be scanned and decoded using a scanning device.

In accordance with an embodiment of the blockchain system, at least one of the blockchain algorithms comprises a security algorithm that determines whether the scanning of a scannable code on a packaging label indicates that the transaction being attempted should not be trusted. The security algorithm performs the following:
upon detecting that the scannable code on a packaging label has been scanned, determining, based on one or more preselected criterion, whether a transaction being attempted should not be trusted; and
if a determination is made that the transaction being attempted should not be trusted, causing the handheld device to notify a user of the handheld device that the transaction should not be trusted.

In accordance with an embodiment of a handheld device being configured to authenticate items using a blockchain network, the handheld device comprises:
one or more processors configured to perform one or more algorithms that:
   process a scannable code disposed on a packaging label of an item to be authenticated using the blockchain network to produce a data signal representing the scannable code;
   decode the data signal representing the scannable code into a decoded data signal, the decoded data signal comprising a nonfungible token (NFT) associated with the item, the NFT being linked to the blockchain network;
   process the decoded data signal to extract the NFT;
   process the extracted NFT to obtain a unique identification (ID) associated with the item from the NFT;
   forward the unique ID in an authentication request to one or more processors of the blockchain network to be processed by said one or more processors of the blockchain network to authenticate the item associated with the NFT;
   if the said one or more processors of the blockchain network is able to authenticate the item, receiving an acknowledgement from the blockchain network that the item is authentic along with preselected data that was used to generate the NFT; and
   displaying an indication on a display device of the handheld device that the item has been authenticated along with the preselected data.

These and other features and advantages will become apparent from the following description, drawings and claims.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1 is a flow diagram of a method performed by one or more processors of the blockchain network in accordance with a representative embodiment to generate an NFT for an item, link the NFT to the blockchain network and encode the NFT in a scannable code, such as a QR code, for example, that can be read by a scanning device.

FIG. 2 is a flow diagram of a method performed by a handheld device in accordance with a representative embodiment to process the scannable code disposed on a label that is attached to or disposed on an item and to communicate with the blockchain network of the present disclosure to authenticate the item.

FIG. 3 is a flow diagram of the process performed by the blockchain network to authenticate the unique ID and communicate with the handheld device in accordance with a representative embodiment.

FIG. 4 is a flow diagram demonstrating a representative embodiment of the processes depicted in blocks 101 and 102 of FIG. 1 for generating web-linked unique IDs and cryptographic certificates for real-world items and storing them in the distributed ledger (i.e., linking them to the blockchain network).

FIG. 5 is a flow diagram demonstrating a representative embodiment of the process of authenticating an item for which the process depicted in FIG. 4 is used to generate the web-linked unique IDs.

FIG. 6 is a block diagram of the blockchain network of the present disclosure in accordance with a representative embodiment.

FIG. 7 is a block diagram of the logic disposed inside one or more nodes of the blockchain system shown in FIG. 6 in accordance with a representative embodiment.

FIG. 8 is a flow diagram of the security algorithm in accordance with a representative embodiment.

FIG. 9 is a block diagram of the logic disposed inside of a handheld device that executes the app of the present disclosure in accordance with a representative embodiment.

### DETAILED DESCRIPTION

The present disclosure is directed to various representative embodiments of a blockchain system and methods that are used in the blockchain system to authenticate items and to detect counterfeit items. Some embodiments of the present disclosure are directed to processes that are performed by a handheld device while other embodiments of the present disclosure are directed to processes that are performed by one or more processors of the blockchain network.

In accordance with a preferred embodiment of the blockchain system and methods,ssss for each item to be authenticated in the blockchain network, the item's label will display a scannable code, such as a Quick Response (QR) code, for example, which is a two-dimensional (2-D) matrix pattern comprising encoded data. For each item to be authenticated by the blockchain system, an NFT is created and encoded into the scannable code. The handheld device is used to scan the scannable code, convert the scanned code into a data signal, extract the NFT from the data signal, process the NFT to obtain a unique identification (ID) of the item associated with the NFT, and forward the unique ID to the blockchain network. The blockchain network then processes the unique ID to authenticate the item associated with the NFT, retrieves the data that was used to create the NFT from memory if authentication is successful, and forwards the retrieved data to the handheld device. The handheld device receives the forwarded data, processes it and causes it to he displayed on the display device of the handheld device to show the user that the item has been successfully authenticated by the blockchain network.

The NFT typically has multiple layers of cryptographic protection and is linked to the blockchain network, which preferably is a permissioned, private blockchain network that stores the NFTs for all of the items in a distributed ledger comprising the blockchain. For each authorized operator (i.e., manufacturer, distributor and/or creator of items) of the blockchain network, an NFT is created for each of the operator's items. There can he many authorized operators and each operator can be a manufacturer, distributor and/or creator of multiple items. For each item, there is a unique NFT. The NFTs are interlinked in the blockchain and the encrypted chain of interlinked NFTs becomes more complex as new NFTs associated with new items are created and added to the blockchain, thus making the NFTs virtually impossible to reproduce or counterfeit.

As indicated above, each NFT has a unique ID associated with it that is cryptographic in nature and preferably is generated using multiple hardened cryptographic algorithms (primarily hashing and signing), thereby making the NFTs extremely difficult to brute-force hack. This ensures that a new NFT cannot simply be generated and cloned on the fly. This also protects against brute-force attacks of the type that ping the application program interface (API) of a computer of the blockchain network asking it for IDs that most likely exist and the data associated with those IDs, which could then be used on to compromise the entire blockchain network in a relatively small amount of time and with a relatively small amount of effort. The cost, resources, and time associated with any attempt to brute-force hack the IDs of the blockchain system of the present disclosure (i.e., the amount of time, effort and resources needed to guess an ID) would be extremely high, making it extremely difficult, if not impossible, to succeed in the attack. In addition, because there are multiple NFTs in the blockchain network of the present disclosure that are cryptographically related, a hacker would have to “guess” more than just one ID to succeed in such an attack.

To add further security to the blockchain system of the present disclosure, the blockchain system and method preferably implement a security algorithm that detects hacking-type behavior and automatically flags such behavior to indicate to the user that an item may be a counterfeit, and the security algorithm can be configured to impose penalties and/or restrictions on the associated account/ID. Furthermore, the security algorithm can be configured to detect labels being scanned in an unusual, undesired and/or odd pattern and to react to this type of attack. Thus, the security algorithm preferably employs a reactive security model. For example, the security algorithm can be configured to determine whether a label has been scanned more times than a preselected threshold (TH) number of times and notify the user or customer that the number of times that the label has been scanned could indicate that the item is counterfeit and/or that the transaction being attempted is invalid.

As another example, the security algorithm can be configured to detect when the age of an item having the label being scanned is beyond a preselected TH age and alert the user or customer that the item may be beyond a suitable age, such as in cases in which the item is an organic product. The security algorithm can be configured in such a way that after the detection of such an event, anyone scanning the scannable code of the label of that item is notified that the item may be compromised or cloned. Additionally, other security measures can be included, such as including invisible ink or a specific type of ink on the labels that can be observed under UV light to aid users in determining whether an item's label is authentic.

In the following detailed description, for purposes of explanation and not limitation, exemplary, or representative, embodiments disclosing specific details are set forth in order to provide a thorough understanding of an embodiment according to the present teachings. However, it will be apparent to one having ordinary skill in the art having the benefit of the present disclosure that other embodiments according to the present teachings that depart from the specific details disclosed herein remain within the scope of the appended claims. Moreover, descriptions of well-known apparatuses and methods may be omitted so as to not obscure the description of the example embodiments. Such methods and apparatuses are clearly within the scope of the present teachings.

The terminology used herein is for purposes of describing particular embodiments only and is not intended to be limiting. The defined terms are in addition to the technical and scientific meanings of the defined terms as commonly understood and accepted in the technical field of the present teachings.

As used in the specification and appended claims, the terms “a,” “an,” and “the” include both singular and plural referents, unless the context clearly dictates otherwise. Thus, for example, “a device” includes one device and plural devices.

Relative terms may be used to describe the various elements' relationships to one another, as illustrated in the accompanying drawings. These relative terms are intended to encompass different orientations of the device and/or elements in addition to the orientation depicted in the drawings.

It will be understood that when an element is referred to as being “connected to” or “coupled to” or “electrically coupled to” another element, it can be directly connected or coupled, or intervening elements may be present.

The term “memory” or “memory device”, as those terms are used herein, are intended to denote a non-transitory computer-readable storage medium that is capable of storing computer instructions, or computer code, for execution by one or more processors. References herein to “memory” or “memory device” should be interpreted as one or more memories or more memory devices. The memory may, for example, be multiple memories within the same computer system. The memory may also be multiple memories distributed amongst multiple computer systems or computing devices.

A “processor”, as that term is used herein encompasses an electronic component that is able to execute a computer program or executable computer instructions. References herein to a computer comprising “a processor” should be interpreted as one or more processors or processing cores. The processor may for instance be a multi-core processor. A processor may also refer to a collection of processors within a single computer system or distributed amongst multiple computer systems. The term “computer” should also be interpreted as possibly referring to a collection or network of computers or computing devices, each comprising a processor or processors. Instructions of a computer program can be performed by multiple processors that may be within the same computer or that may be distributed across multiple computers.

A “handheld device”, as that term is used herein, refers to any device that is adapted to be held in the hand of a user and having one or more processors that can be configured to perform the computer algorithms described below as being performed by a handheld device, such as, for example, a smart phone, a notebook or laptop computer, a personal digital assistant (PDA), a scanning device such as a scannable code reader used at POSs to scan items being purchased, a digital tablet, etc.

An “operator,” as that term is used herein, denotes a manufacturer, distributor and/or creator of items for which an NFTs are created in accordance with the present disclosure.

Exemplary, or representative, embodiments will now be described with reference to the figures, in which like reference numerals represent like components, elements or features. It should be noted that features, elements or components in the figures are not intended to be drawn to scale, emphasis being placed instead on demonstrating inventive principles and concepts.

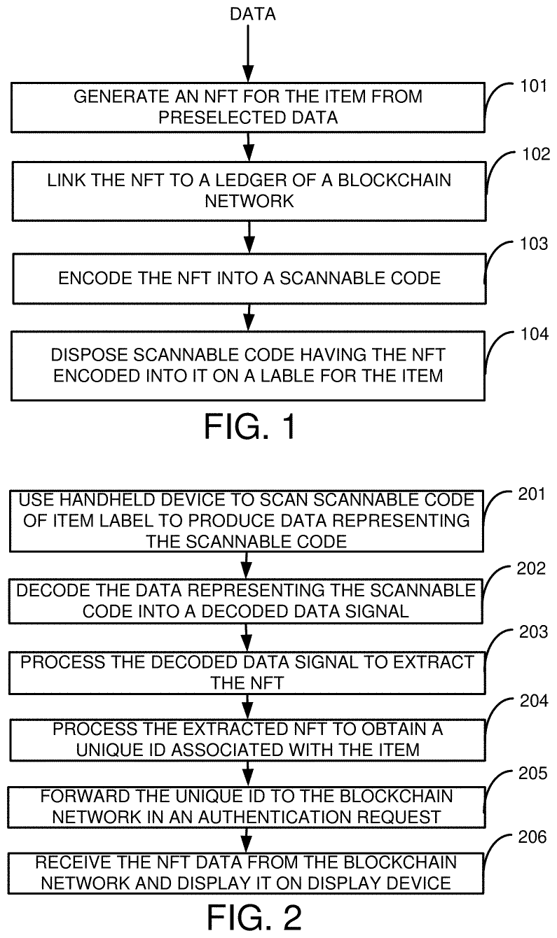

FIG. 1 is a flow diagram of a method performed by one or more processors of the blockchain network in accordance with a representative embodiment to generate an NFT for an item, link the NFT to the blockchain network and encode the NFT in a scannable code, such as a QR code, for example, that can be read by a scanning device. For an item to later be authenticated using the blockchain network, an NFT is generated for the item by performing one or more encryption algorithms that encrypt preselected data that identifies and characterizes the item, as indicated by block 101. Once the NFT has been generated, it is linked to a distributed ledger of the blockchain network, as indicated by block 102. In the step represented by block 103, the NFT is encoded into a scannable code, which is a preselected code that can be scanned and decoded using a scanning device, such as a bar code reader or QR code reader, for example.

Once the steps represented by blocks 101-103 have been performed, the scannable code having the NFT encoded therein can be printed on, embedded in or otherwise disposed on a label that will be, or already has been, attached to or disposed on the item, as indicated by block 104. The steps of producing the label and causing the scannable code having the NFT encoded therein to be disposed on the label can be performed as part of the method represented by FIG. 1 or they can be part of a separate process that is performed by, for example, the manufacturer, distributor and/or creator of the item. The steps represented by blocks 101-103 preferably are performed by the blockchain network, but once the scannable codes having the linked NFTs encoded in them have been generated, the scannable codes represent data structures that can be stored in memory and communicated to one or more other parties responsible for label generation and placement of the scannable codes on the labels.

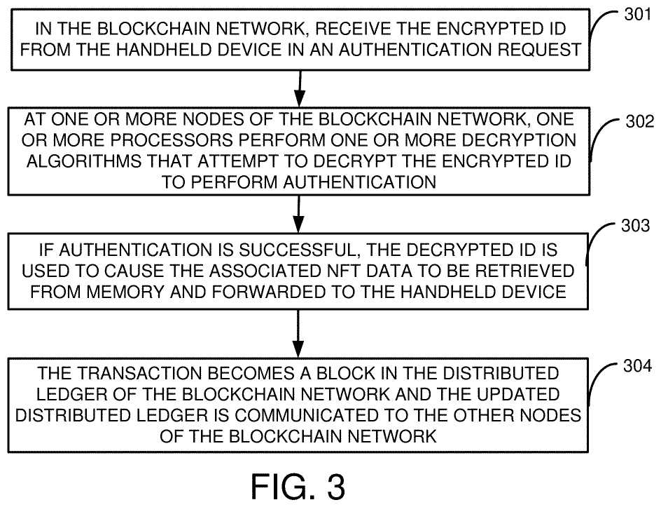

The steps represented by blocks 101-103 can be implemented in a number of ways that can vary depending on the blockchain network in which the method is employed. For example, if the method is employed in a private blockchain network, the computer code that is used to generate the NFT, link it to the blockchain network and encode it into a scannable code can be very different from the computer code that would be used for these purposes if the method is employed in a public blockchain network, such as the Ethereum blockchain network, for example. For the Ethereum blockchain network, there is a specific algorithm that is used for minting NFTs and linking them to the Ethereum blockchain network, which can be different from the process used in block 101. The processes represented by block 101 could be the same as, for example, the Ethereum minting and linking processes, but could also be different from those processes. An example of the processes represented by blocks 101-103 performed in the assignee's private blockchain network is described below with reference to FIG. 3.

FIG. 2 is a flow diagram of a method performed by a handheld device in accordance with a representative embodiment to process the scannable code disposed on a label that is attached to or disposed on an item and to communicate with the blockchain network of the present disclosure to authenticate the item. With a handheld device, the scannable code disposed on a label of the item to be authenticated using the blockchain network is scanned to produce data representing the scannable code, as indicated by block 201. One or more processors of the handheld device decode the data representing the scannable code into a decoded data signal, as indicated by block 202. If the item is authentic, the decoded data signal comprises the NFT associated with the item that was previously generated and linked to the blockchain network in steps 101 and 102 of FIG. 1. The one or more processors of the handheld device process the decoded data signal to extract the NFT, as indicated by block 203, process the extracted NFT to obtain a unique ID associated with the item from the NFT, as indicated by block 204, and forward the unique ID to one or more processors of the blockchain network to be processed by them to authenticate the item associated with the NFT, as indicated by block 205.

When the blockchain network receives the unique ID in an authentication request from the handheld device, one or more processors of the blockchain network attempt to authenticate the item associated with the request. The unique ID received from the handheld device is encrypted. Authentication can be performed in a number of ways. In cases in which the blockchain network is a public blockchain network, authentication is typically performed by having multiple processors of the blockchain network located at different nodes of the network simultaneously perform a consensus algorithm. A variety of known consensus algorithms, and variations thereof, can be used for this purpose, including, for example, the proof of work algorithm, the proof of stake algorithm, the proof of elapsed time algorithm, the byzantine fault tolerance algorithm, etc. A new consensus algorithm can also be used for this purpose. In accordance with a preferred embodiment, the blockchain network is a private network, or at least the portion of the blockchain network that is responsible for creating NFTs and for performing authentication is a private, permissioned network. In accordance with this preferred embodiment, a single processor or computer of the private portion or private network performs one or more blockchain algorithms that decrypt the encrypted unique ID to perform authentication, retrieve the associated NFT data from memory and forward the NFT data to the handheld device.

If authentication is successful, the transaction becomes a block in the blockchain network and the distributed ledger of the blockchain network is updated to include the block. Each node in the network then receives a copy of the updated ledger. The handheld device receives the NFT data and displays it on a display device to the user, as indicated by block 206.

FIG. 3 is a flow diagram of the process performed by the blockchain network to authenticate the unique ID and communicate with the handheld device. One or more processors of the blockchain network receive the encrypted unique ID in an authentication request sent to the network by the handheld device, as indicated by block 301. At one or more nodes of the blockchain network, one or more processors perform one or more decryption algorithms that attempt to decrypt the encrypted unique ID to perform authentication, as indicated by block 302. If authentication is successful, the decrypted unique ID is used to cause the associated NFT data to be retrieved from memory and forwarded to the handheld device, as indicated by block 303. The transaction preferably becomes a block in the blockchain network and the distributed ledger of the blockchain network is updated to include the block and is communicated to the other nodes of the blockchain network, as indicated by block 304.

In cases in which the blockchain network is a private blockchain network, it is not necessary for multiple processors at multiple nodes to simultaneously perform NFT mining (i.e., performing a consensus algorithm to authenticate the transaction and then updating a distributed ledger), but doing so can increase the robustness and security of the blockchain network. For example, in a private blockchain network, a dedicated server can be responsible for receiving the authentication request, performing any algorithms for decrypting the encrypted unique ID, retrieving the NFT data associated with the unique ID, forwarding the NFT data to the handheld device, and updating its own ledger. In private blockchain networks, other features can be implemented in those networks to enhance security and prevent the network from being compromised by unauthorized users that may attempt attacks on the network.

### Creation of Cryptographic Certificate Comprising an NFT

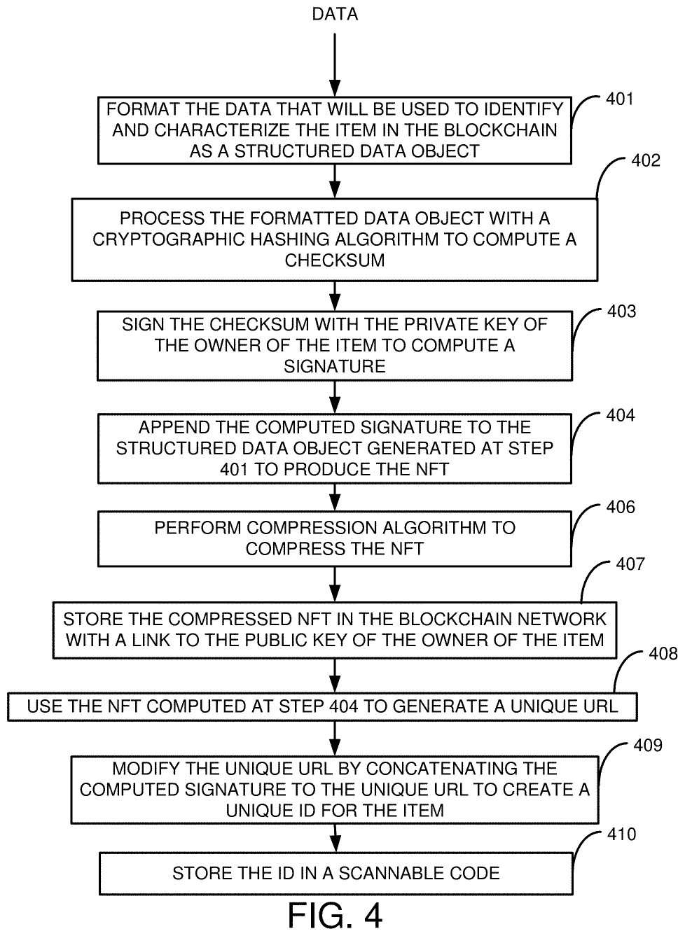

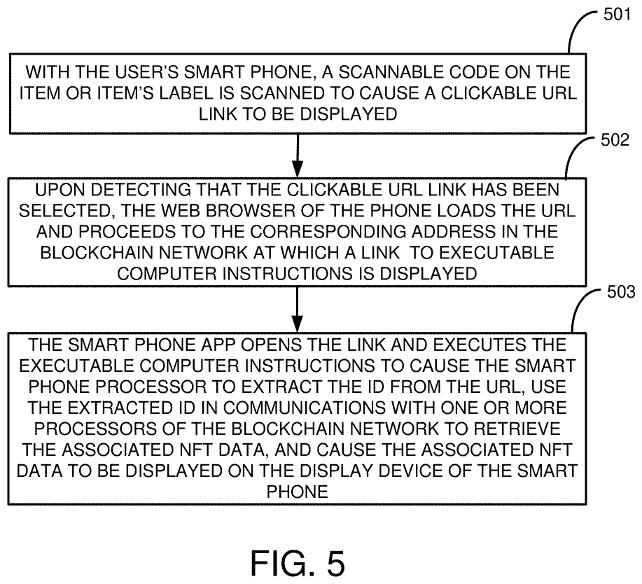

FIG. 4 is a flow diagram demonstrating an exemplary, or representative, embodiment of the processes depicted in blocks 101 and 102 of FIG. 1 for generating web-linked unique IDs and cryptographic certificates for real-world items and storing them in the distributed ledger (i.e., linking them to the blockchain network). FIG. 5 is a flow diagram demonstrating an exemplary, or representative, embodiment of the process of authenticating an item for which the process depicted in FIG. 4 is used to generate the web-linked unique IDs.

It should be noted that the inventive principles and concepts of the present disclosure are not limited to the real-world item being any particular type of item. The item can be, for example, something that is grown (e.g., fruit, vegetables, cannabis), something that is raised (e.g., poultry, meat, fish, etc.), something that has been manufactured (e.g., clothing, personal accessories, jewelry), something that has been created (e.g., art work, a music recording, a video recording), etc. The inventive principles and concepts are suitable for use with any item for which it is desirable to enable validation or authentication of the item to prevent or detect counterfeiting of the item or fraudulent transactions involving the item.

The process represented by the flow diagram of FIG. 4 are performed by one or more designated processors of the blockchain network of the present disclosures. Preferably, the portion of the blockchain network involved with creation, or minting, of the NFTs is private to enhance security. This private portion can be configured to interface with a public blockchain network. The first step in the process of creating the NFT in accordance with this representative embodiment is represented by block 401 of the flow diagram of FIG. 4. Block 401 represents the process of creating a structured data object in, for example, a JavaScript object notation (JSON) format or MessagePack format. The structured data object comprises the data, sometimes referred to in known NFT minting processes as “metadata,” that will ultimately be stored as the NFT data in the blockchain. For purposes of describing an exemplary embodiment, it will be assumed that the JSON format is used for this purpose, but any suitable structured data object format could be used for this purpose.

The data that is formatted into the JSON-formatted data object will typically be data that identifies and characterizes the item for which the NFT is being created. For example, if the item is an organic item that is grown on a farm, the data may comprise one or more of, for example, information identifying what the item is, information identifying the particular farm where the item was grown, the date that the item was harvested, any brand associated with the item, information identifying the batch to which the item belongs, information identifying the party or association that grew the batch, information identifying any certifications associated with the item (e.g., a Farm Organic Certification), information identifying any tests that have been performed on the item or on the corresponding batch, any test results associated with testing of the item or the corresponding batch, etc. The latter two types of information can be useful in cases in which it may be desirable for the NFT to include a record of evidence showing compliance with regulations or statutes of a governmental organization (e.g., the Food and Drug Administration (FDA)).

In the case where the item is an article of manufacture, such as, for example, a piece of jewelry, a handbag, purse or pocketbook, a consumer electronic device, a vehicle, etc., the data that is used to identify and characterize the item may be one or more of, for example, information identifying what the item is, information identifying the manufacturer, information identifying the manufacturing facility, information identifying the batch to which the item belongs, information identifying the part number, model number and/or name for the item, information identifying the style of the item, any brand name associated with the item, information identifying any certifications that have been achieved, information identifying any tests that have been performed on the item or the batch, information identifying any testing results, etc.

The data that is used for the purposes of identifying and characterizing the item can be any information that meaningfully identifies and characterizes the item. The inventive principles and concepts of the present disclosure are not limited with respect to the type of data that is used to identify and characterize the item. One of the primary purposes of blockchain networks is to ensure that ownership and provenance can be verified with certainty, thereby preventing counterfeiting or invalid transfers of the NFTs. Therefore, any data that is useful or suitable for this purpose can be included in the structured data object.

In the step represented by block 402 in the flow diagram of FIG. 4, a cryptographic hashing algorithm is performed that processes the JSON-formatted data object with a cryptographic hashing function to compute a fixed-length fingerprint, which is essentially a checksum. The cryptographic hashing algorithm that is used for this purpose can be, for example, the BLAKE2b cryptographic hashing algorithm, which is a known hashing algorithm described in Request For Comment (RFC) 7693. The data that is in the form of the checksum includes all of the property titles of the JSON-formatted object assembled in alphabetical order and concatenated with their property values. An example of the end results of the concatenation is aPropertyValueofAbPropertyValueofB.

In the step represented by block 403, the checksum is cryptographically signed using the owner's or operator's private key, which is part of the blockchain of private portion of the blockchain network and is not known outside of the private portion except to the owner or operator of the item. The terms “owner” and “operator” are used herein to denote the manufacturer or creator of the original item. The process represented by block 403 generates a computed signature.

In the step represented by block 404, the computed signature is appended to the JSON-formatted data object generated at step 401 to produce the NFT. In the step represented by block 406, an optional compression algorithm is performed that processes the NFT in accordance with a compressed binary data structure algorithm to produce a compressed binary NFT. Compressing the NFT prior to storing it in memory in the blockchain network reduces the amount of “gas”, or processing overhead, that is needed by the blockchain network to process and store the NFT and to later perform the consensus algorithm(s) that is used to verify the authenticity of the NFT. Reducing the amount of processing overhead that is needed for this purpose is important since the NFT will be cryptographically linked to other blocks of the blockchain.

In the step represented by block 407, the compressed binary NFT is stored in the blockchain and linked to the owner's public key. The stored NFT with the link to the owner's public key is now considered immutable and can be verified using a process similar to that described above, as will be described below in more detail with reference to FIG. 5. Subsequently, a user will be able to authenticate the NFT data using the owner's or operator's public key to determine whether the data has been modified or is authentic, as will be described below in more detail with reference to FIG. 5.

In the step represented by block 408, the cryptographic certificate comprising the NFT is used to generate a unique URL of an existing URL structure of a preselected domain. In the step represented by block 409, the unique URL is modified by concatenating the computed signature generated at block 403 to the URL generated at block 408 to generate the unique ID for the item discussed above, which preferably is a UTF-8 valid ID. Creating the unique ID in this manner ensures that no ID used in the blockchain network is the same as any other ID used in the blockchain network and that the IDs can be safely used in a URL scheme for any number of NFTs created in the future. An example of a URL created by the process of block 409 is: https://example.com/NFT/ID(PUBLICKEY_SIGNED(CHECKSUM(NFT/CRYPTOGRAPH IC CERTIFICATE))).

At the step represented by block 410, the unique ID comprising the signature concatenated to the unique URL is stored inside of a scannable code, such as QR code, for example. Although other types of scannable codes can be used for this purpose, the remainder of the present disclosure assumes that a QR code is used for this purpose. As will be described below in more detail with reference to FIG. 5, when a smart phone executing the smart phone blockchain app of the present disclosure scans the QR code, the associated NFT data will be displayed on the display device of the smart phone, verifying to the user that the NFT is authentic. The term “scannable code” is used herein to refer to whichever desired image-based encoding of data is used for this purpose, including, but not limited to, a QR code, a traditional barcode or any sort of matrix code.

It should be noted that the processes described above with reference to the flow diagram of FIG. 4 are blockchain-agnostic in that they can be adapted to any blockchain network. The processes depicted in FIG. 4 have been customized or tailored to the assignee's private blockchain network. It should be noted, however, that these processes can vary greatly depending on the particular blockchain network in which they are implemented. The particular processes described herein have been chosen because they use current cryptography standards that have been tested and documented in the known Libsodium software library. As will be understood by those of skill in the art, many variations can be made to those processes within the scope of the inventive principles and concepts of the present disclosure. For example, the processes described above can be tailored for, and transplanted into, a larger-scale blockchain network or a third party blockchain network, such as, for example, the well-known Ethereum blockchain network, as will be understood by those of skill in the art in view of the description provided herein.

### NFT Authentication/Verification

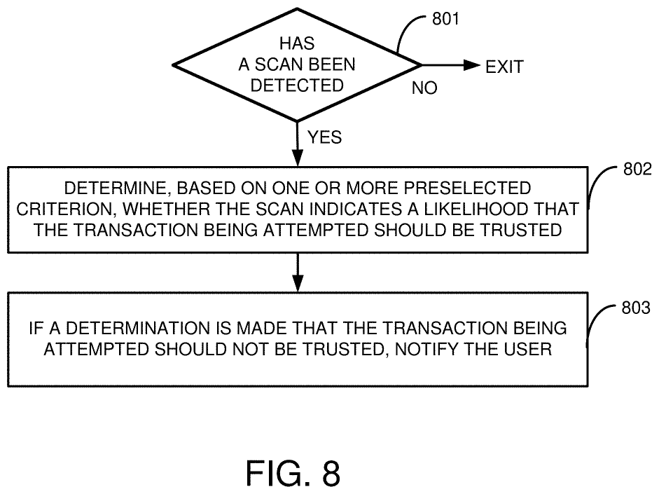

In accordance with the present disclosure, NFT ownership and provenance can be verified by a user or customer at a point-of-sale (POS) location or terminal. For this purpose, a representative embodiment of the present disclosure is directed to an embodiment in which the handheld device comprises a smart phone that executes a smart phone app that scans the scannable code discussed above, processes the output of the scan and communicates with one or more processors of the private portion of the blockchain network to retrieve the NFT data and cause it to be displayed on the display device of the smart phone to allow the user to verify ownership and provenance of the NFT. As will be described below in more detail with reference to FIG. 8, preferably an additional anti-counterfeiting algorithm is used in conjunction with the algorithm represented by FIG. 5 to ensure that the item has not been counterfeited and/or to ensure that the item is otherwise suitable for use or consumption.

With reference to block 501 of the flow diagram of FIG. 5, when a user seeks to verify the authenticity of an item at, for example, a POS location, the user uses his or her smart phone to scan the QR code disposed on the item's label or on the item itself. To do this, the user opens the camera app installed on his or her smart phone or opens a part of an app that has a camera feature with barcode reading support. All Android and iPhone camera apps support QR code reading and display the data in a notification-style banner. The user scans the QR code, the smart phone displays a banner that appears as a clickable URL link for connecting the user's phone to an Internet address of an Internet domain, which in this example is the assignee's Internet domain, “akerna.com.” The URL of the clickable URL link is the URL that was created at block 409 in FIG. 4. The first part of the URL preferably is the network domain and the last part is the cryptographically-deterministically-generated signed hash, which is the UTF-8 valid ID generated at block 409 of FIG. 4. An example of the URL might be: https://akerna.com/id/83sd39800s0987j9sj.

When the user clicks the banner, as indicated by block 502, the URL is opened in the default web browser app of the phone, which can be any web browser, but is typically a Google Chrome/Blink-based, a Safari/Webkit-based web browser, a Firefox web browser, etc. The web browser app loads the URL, thereby causing the phone to be connected to a network address at which a link to executable computer instructions is located. The link to the executable instructions can be displayed to the user on the display of the smart phone. If the smart phone app of the present disclosure is already installed on the user's smart phone, the default of the smart phone app preferably is to automatically open the displayed link and execute the corresponding computer instructions on the processor of the smart phone. Alternatively, the smart phone app of the present disclosure can display a prompt that prompts the user to click on the link in order to cause the computer instructions to be executed.

If the smart phone app of the present disclosure is not already installed on the user's smart phone at this time, preferably the user's smart phone connects to the default app store on the smart phone and the user is prompted to download the smart phone app of the present disclosure. Once the smart phone app of the present disclosure has been installed on the smart phone, the link to the executable computer instructions is opened. When the smart phone opens the link and the processor executes the computer instructions, it extracts the unique ID from the URL that was modified at step 409 of FIG. 4. To accomplish this, the processor parses or otherwise uses the URL to navigate to a state that selects the ID using, for example, Regex or a split operation to specifically select the ID in the URL. Using the ID, the smart phone processor then communicates with one or more processors of the blockchain network to retrieve the associated NFT data from the blockchain network and cause it to be displayed to the user on the display device of the smart phone. During this process, the blockchain network performs the process described above with reference to FIG. 3.

Some of the processes represented by block 503 are performed by one or more processors of the smart phone and some of the processes represented by block 503 are performed by one or more processors of the blockchain system. The smart phone app of the present disclosure and the software executed by one or more processors of the blockchain system are configured to interact with one another to perform all of the tasks associated with the various layers typically involved in blockchain technology, such as, for example, the application layer, the services layer, the semantic layer, the network layer and the infrastructure layer. Because persons of skill in the art understand the manner in which hardware and software can be configured to perform the processes associated with the various layers of a blockchain network, a detailed discussion of the hardware and software implementations used for this purpose are not described herein in the interest of brevity.

The processes represented by blocks 501 and 502 can be performed using known functionality that is currently implemented in smart phones today. As indicated above, smart phones available today typically have a camera app with scannable code reading support that reads a QR code and causes a web browser app of the smart phone to link to an address on the Internet. The smart phone app of the present disclosure can be configured to interact with such existing apps to cause the smart phone to connect to the address at which the link to the executable computer instructions of the present disclosure is located, at which point the smart app of the present disclosure can be automatically triggered to open the link and execute the executable computer instructions that cause the processes represented by block 503 to be performed. Alternatively, the smart phone app of the present disclosure can be integrated with the camera app having scannable code reading functionality.

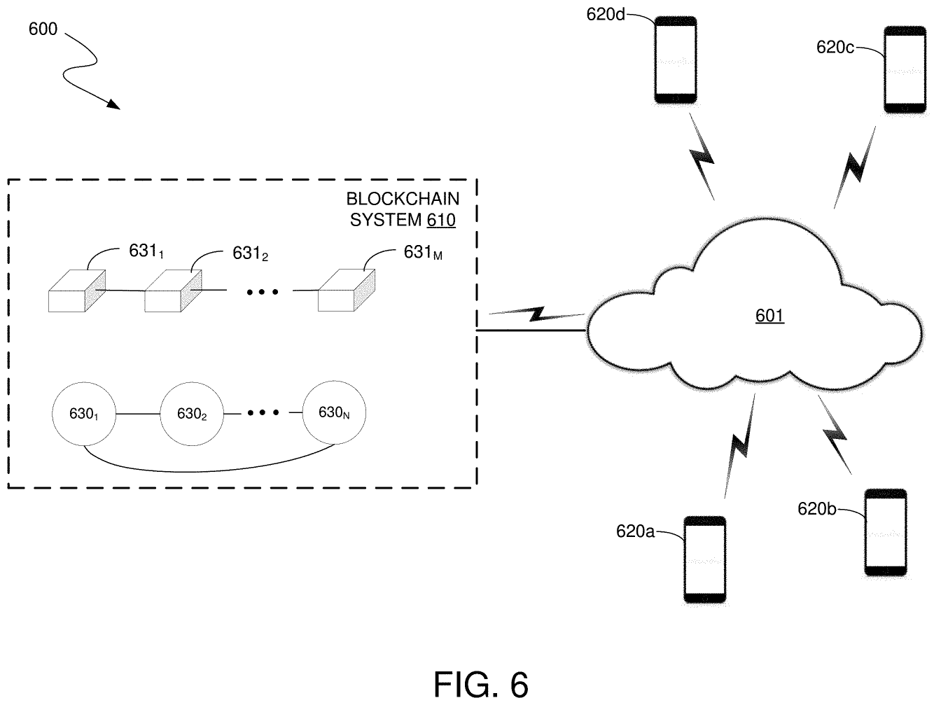

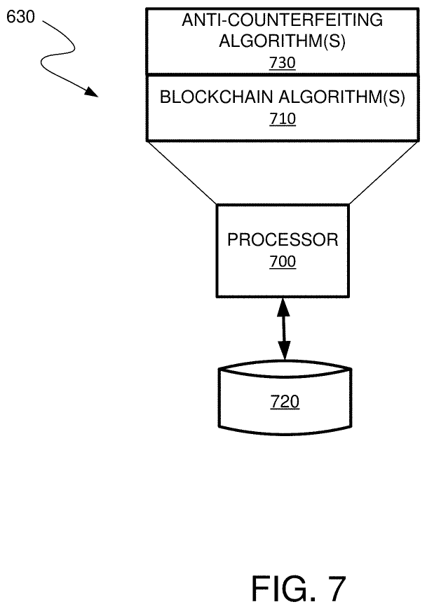

FIG. 6 is a block diagram of the blockchain network 600 of the present disclosure in accordance with a representative embodiment. The blockchain network 600 comprises a blockchain system 610 comprising nodes 630₁ through 630_{N}, where N is a positive integer that is greater than or equal to 1. As will be described below with reference to FIG. 7, each node comprises one or more processors that perform the processes described above with reference to FIG. 1, 3 or 4, depending on which of those embodiments is being implemented by the system 610. The blockchain system 610 is in communication via a wired or wireless link with an external network 601, which can be a public or private network or a combination of public and/or private networks. Handheld devices 620a-620d have the app of the present disclosure installed on them as described above with reference to the flow diagrams of FIGS. 2 and 5. Running the app of the present disclosure, the handheld devices 620a-620d can be used at POSs to perform the operations described above with reference to FIGS. 2 and 5 to communicate with the blockchain system 610 via the network 601.

The nodes 630₁-630_{N} are interconnected by a network that allows them to communicate with one another, and each of the nodes 630₁-630_{N} comprises one or more processors that are configured to allow the nodes to perform operations such as those described above with reference to blocks 101-103 of FIG. 1 and blocks 301-304 of FIG. 3. The processors of the nodes do not all have to have the same configurations and do not all have to perform the same operations. For example, the processor of one of the nodes can be responsible for performing the operations depicted in blocks 101 and 102, whereas the processors of all of the other nodes can be responsible for performing the operations depicted in blocks 301, 302, 303 and/or 304 of FIG. 3.

When the processes of FIG. 1, 3 or 4 are performed to create a new NFT, a new block associated with the NFT is added to the blockchain. The blocks 631₁-631_{M} in FIG. 6 represent the blocks of the blockchain and the lines interconnecting the blocks 631₁-631M represent the encryption that links the blocks together in the blockchain, where M is a positive integer that is greater than or equal to 1. The blockchain comprising the cryptographically-linked blocks 631₁-631M is essentially the distributed ledger of the blockchain network 600.

FIG. 7 is a block diagram of the logic disposed inside of one of the nodes 630₁-630_{N} of the blockchain system 610 shown in FIG. 6. The nodes 630₁-630_{N} can have the same logic configuration, but it is not necessary for them to have the same logic configuration. For ease of discussion, it will be assumed that the nodes 630₁-630_{N} have the same logic configuration, represented by the block diagram for one of the nodes 630 shown in FIG. 7. It will also be assumed that each node is configured to perform all of the operations depicted in blocks 101-103 of FIG. 1, blocks 301-304 of FIG. 3, or blocks 401-410 in FIG. 4, depending on which embodiment is implemented in the block chain system 610.

The node 630 comprises a processor 700 that is configured to perform the blockchain algorithms described above, which are represented in FIG. 7 collectively as “blockchain algorithms 710”. As indicated above, however, some of these algorithms can be performed by a processor of one node of the system 610 while others can be performed by processors of other nodes of the blockchain system 610. At least one memory device 720 of the node 630 stores computer instructions comprising the blockchain algorithms 710. The memory device 720 can also store the ledger represented by blocks 631₁-631M, although the ledger could be stored at some other location. In cases where the system 610 comprises multiple nodes, each node 630 preferably receives a copy of the updated ledger anytime the ledger is updated, i.e., the updated ledger is distributed among the nodes.

In addition to these blockchain algorithms 710, in some embodiments, the processor 700 is configured to perform one or more of the aforementioned security algorithms 730. The computer instructions for implementing these security algorithms 730 can also be stored in memory device 720.

FIG. 8 is a flow diagram of the security algorithm 730 in accordance with a representative embodiment. In accordance with this embodiment, block 801 corresponds to the blockchain system 610 shown in FIG. 6 detecting that the scannable code on an item label has been scanned. As indicated above, when a handheld device executing the app of the present disclosure forwards the unique ID to the blockchain network at the step represented by block 205, it is sent along with a request to authenticate the associated NFT. In accordance with this embodiment, block 801 corresponds to one or more of the nodes of blockchain system 610 detecting that the scannable code has been scanned when the authentication request is received from the handheld device.

When the blockchain system 610 detects that a scannable code has been scanned at block 801, one or more of the nodes 630₁-630_{N} determine, based on some preselected criteria, whether the transaction being attempted is a bona fide attempt or an unauthorized attempt, as indicated by block 802. The determination that is made at block 802 as part of the security algorithm 730 can be made as part of the blockchain algorithms 710 or it can be a separate determination that is made before or after the blockchain algorithms 710 have been performed. For example, the determination of block 802 can be made after the process represented by block 303 of FIG. 3 has been performed, but before the process represented by block 304 has been performed. Making the determination at this point in the process ensures that the attempted transaction does not become a block of the blockchain until the security algorithm 730 determines that the transaction being attempted is a bona fide or authorized attempt.

As another example, the determine of block 802 can be made after the process represented by block 301 of FIG. 3 has been performed, but before the process represented by block 302 has been performed. For purposes of discussion, it will be assumed that the determination of block 802 is made after the process represented by block 303 has been performed, but before the process represented by block 304 has been performed.

The criteria that are used to make the determination of block 802 can include one or more factors that indicate a likelihood that the transaction being attempted is not bona fide or authorized. As indicated above, the security algorithm can be configured to detect labels being scanned in an unusual, undesired and/or odd pattern and to react to this type of attack. At block 802, the blockchain system 610 can analyze the distributed ledger to determine whether or not the label associated with the unique ID that was received in the authentication request from the handheld device has been scanned multiple times, the locations at which those scans occurred, the dates and times when the scans occurred, the amount of time that lapsed between the time that the most recent scan occurred and when the item associated with the unique ID was first created. one or more of these criteria can be used to determine the likelihood that the transaction being attempted is bona fide or authorized.

For example, if the same label was scanned on the same day at two different locations, the security algorithm can analyze the dates, times and locations of those scans and determine that there is a high likelihood that the transaction being attempted is fraudulent. As another example, the security algorithm can determine that a transaction being attempted is not a bona fide transaction if the security algorithm determines that a label has been scanned more than a preselected TH number of times. As another example, the security algorithm can determine that the transaction being attempted is fraudulent or unauthorized if the length of time between the date on which the current scan occurred and the date on which the item was created indicates that the item has exceeded its life expectancy or is beyond a suitable age, such as in cases in which the item is an organic product. All of this information can be can be stored in the distributed ledger for each NFT that is created and for any transactions that have occurred relating to each NFT.

At block 803, the user is notified of the determination that was made at block 802. This can be accomplished by the display device of the handheld device displaying a message to the user informing the user of the determination that was made at block 802, such as a message that informs the user that, for example, the item may be a counterfeit or clone, the item may be beyond a suitable age for consumption, the item was previously purchased, multiple attempts have been made to purchase the item, etc. The security algorithm can be configured in such a way that after the detection of such an event, anyone scanning the scannable code of the label of that item is notified that the item may be compromised or cloned. The notification can be any notification that suitably alerts the user and it can be audio, visual, audio-visual.

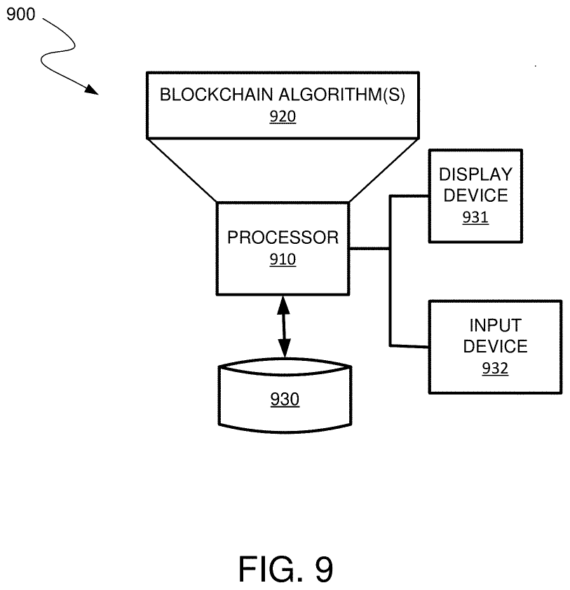

FIG. 9 is a block diagram of the logic 900 disposed inside of a handheld device that executes the app of the present disclosure in accordance with a representative embodiment. To perform the processes discussed above with reference to FIGS. 2 and 5, one or more processors 910 executes the app of the present disclosure, which is represented in FIG. 9 by blockchain algorithm(s) 920. At least one memory device 930 stores computer instructions comprising the blockchain algorithms 920. The memory device 930 can also store other computer programs, such as the computer programs for scanning and decoding the QR code. A display device 931 of the handheld device can be used to display the notification to the user indicated by block 803. The handheld device can include additional components, such as an input device 932 (e.g., a key pad). The display device 931 can also serve as an input device.

It should be noted that the inventive principles and concepts have been described with reference to representative embodiments, but that the inventive principles and concepts are not limited to the representative embodiments described herein. Although the inventive principles and concepts have been illustrated and described in detail in the drawings and in the foregoing description, such illustration and description are to be considered illustrative or exemplary and not restrictive; the invention is not limited to the disclosed embodiments. Other variations to the disclosed embodiments can be understood and effected by those skilled in the art, from a study of the drawings, the disclosure, and the appended claims.

What is claimed is:

1. A method for using a blockchain network to protect items from being counterfeited, the method comprising:
for an item to be protected using the blockchain network:
generating a nonfungible token (NFT) for the item by performing one or more encryption algorithms that encrypt preselected data that identifies and characterizes the item;
linking the NFT to a ledger of the blockchain network; and
encoding the NFT into a scannable code to be disposed on a packaging label of a package or container that will be used to package or contain the item, the scannable code being a preselected code that can be scanned and decoded using a scanning device.

2. The method of claim 1, further comprising:
disposing the scannable code having the NFT encoded therein on the packaging label.

3. The method of claim 1, further comprising:
disposing the packaging label on the package or container.

4. The method of claim 1, wherein the item comprises at least one of something that was grown, something that was raised, something that was manufactured and something that was created.

5. The method of claim 4, wherein said something that was grown is selected from the group comprising fruit, vegetables and cannabis, wherein said something that is raised is selected from the group comprising poultry, meat and fish, wherein said something that is manufactured is selected from the group comprising clothing, personal accessories and jewelry, and wherein said something that has been created is selected from the group comprising art work, a music recording and a video recording.

6. The method of claim 4, wherein the item comprises something that was grown, and wherein the preselected data comprises at least one of (1) information identifying what the item is, (2) information identifying a particular farm where the item was grown, (3) a date that the item was harvested, (4) any brand associated with the item, information identifying a batch to which the item belongs, (5) information identifying a party or association that grew the batch, (6) information identifying any certifications associated with the item, (7) information identifying any tests that have been performed on the item or on the corresponding batch, and (8) any test results associated with testing of the item or the corresponding batch.

7. The method of claim 4, wherein the item comprises something that was manufactured or created, and wherein the preselected data comprises at least one of (1) information identifying what the item is, (2) information identifying the manufacturer or creator, (3) information identifying the manufacturing facility, (4) information identifying a batch to which the item belongs, (5) information identifying a part number, model number or name for the item, (6) information identifying a style of the item, (7) any brand name associated with the item, (8) information identifying any certifications associated with the item, (9) information identifying any tests that have been performed on the item or the batch, (10) information identifying any testing results associated with testing of the item or the corresponding batch.

8. The method of claim 1, wherein generating the NFT comprises:
(1) formatting said preselected data into a structured data object;
(2) processing the formatted data object with a cryptographic hashing algorithm to compute a checksum;
(3) signing the checksum with a private key associated with an original owner of the item to compute a signature;
(4) appending the computed signature to the structured data object to produce the NFT;
(5) performing a compression algorithm that compresses the NFT; and
(6) storing the compressed NFT in a memory device of the blockchain network.

9. The method of claim 8, wherein generating the NFT further comprises:
(7) using the NFT produced at step (4) to generate a unique Uniform Resource Locator (URL) for the item; and
(8) modifying the unique URL by concatenating the computed signature to unique URL to create a unique identifier (ID) for the item.

10. A method for authenticating an item using a blockchain network, the method comprising:
with a handheld device:
scanning a scannable code disposed on a packaging label of an item to be authenticated using the blockchain network and producing a data signal representing the scannable code;
in one or more processors of the handheld device:
decoding the data signal representing the scannable code into a decoded data signal, the decoded data signal comprising a nonfungible token (NFT) associated with the item, the NFT being linked to the blockchain network;
processing the decoded data signal to extract the NFT;
processing the extracted NFT to obtain a unique identification (ID) associated with the item from the NFT;
forwarding the unique ID in an authentication request to one or more processors of the blockchain network to be processed by said one or more processors of the blockchain network to validate the item associated with the NFT;
if the said one or more processors of the blockchain network is able to authenticate, receiving an acknowledgement from the blockchain network that the item is authentic along with preselected data that was used to generate the NFT; and
displaying an indication on a display device of the handheld device that the item has been authenticated along with the preselected data.

11. The method of claim 10, wherein the item comprises at least one of something that was grown, something that was raised, something that was manufactured and something that was created.

12. The method of claim 11, wherein said something that was grown is selected from the group comprising fruit, vegetables and cannabis, wherein said something that is raised is selected from the group comprising poultry, meat and fish, wherein said something that is manufactured is selected from the group comprising clothing, personal accessories and jewelry, and wherein said something that has been created is selected from the group comprising art work, a music recording and a video recording.

13. The method of claim 12, wherein the item comprises something that was grown, and wherein the preselected data comprises at least one of (1) information identifying what the item is, (2) information identifying a particular farm where the item was grown, (3) a date that the item was harvested, (4) any brand associated with the item, information identifying a batch to which the item belongs, (5) information identifying a party or association that grew the batch, (6) information identifying any certifications associated with the item, (7) information identifying any tests that have been performed on the item or on the corresponding batch, and (8) any test results associated with testing of the item or the corresponding batch.

14. The method of claim 11, wherein the item comprises something that was manufactured or created, and wherein the preselected data comprises at least one of (1) information identifying what the item is, (2) information identifying the manufacturer or creator, (3) information identifying the manufacturing facility, (4) information identifying a batch to which the item belongs, (5) information identifying a part number, model number or name for the item, (6) information identifying a style of the item, (7) any brand name associated with the item, (8) information identifying any certifications associated with the item, (9) information identifying any tests that have been performed on the item or the batch, (10) information identifying any testing results associated with testing of the item or the corresponding batch.

15. A method of authenticating an item in a blockchain network, the method comprising:
in one or more processors of the blockchain network:
receiving an authentication request from a handheld device, the authentication request comprising a unique identifier (ID) obtained from a nonfungible token (NFT) that was embedded in a scannable code disposed on a packaging label of a package or container for the item;
processing the unique ID to determine whether or not the item is authentic;
if a determination is made that the item is authentic, retrieving preselected data that was used to create the NFT from one or more memory devices and forwarding the preselected data that was used to create the NFT to the handheld device.

16. The method of claim 15, wherein the item comprises at least one of something that was grown, something that was raised, something that was manufactured and something that was created.

17. The method of claim 16, wherein said something that was grown is selected from the group comprising fruit, vegetables and cannabis, wherein said something that is raised is selected from the group comprising poultry, meat and fish, wherein said something that is manufactured is selected from the group comprising clothing, personal accessories and jewelry, and wherein said something that has been created is selected from the group comprising art work, a music recording and a video recording.

18. The method of claim 16, wherein the item comprises something that was grown, and wherein the preselected data comprises at least one of (1) information identifying what the item is, (2) information identifying a particular farm where the item was grown, (3) a date that the item was harvested, (4) any brand associated with the item, information identifying a batch to which the item belongs, (5) information identifying a party or association that grew the batch, (6) information identifying any certifications associated with the item, (7) information identifying any tests that have been performed on the item or on the corresponding batch, and (8) any test results associated with testing of the item or the corresponding batch.

19. A blockchain system for using a blockchain network to protect items from being counterfeited, the system comprising:
a memory device; and
one or more processors configured to perform one or more blockchain algorithms that:
generate a nonfungible token (NFT) for each item by performing one or more encryption algorithms that encrypt preselected data that identifies and characterizes the item;
link the NFT to a ledger of the blockchain network; and
encode the NFT into a scannable code to be disposed on a packaging label of a package or container that will be used to package or contain the item, the scannable code being a preselected code that can be scanned and decoded using a scanning device.

20. The blockchain system of claim 19, wherein at least one of the blockchain algorithms comprises a security algorithm that determines whether the scanning of a scannable code on a packaging label indicates that the transaction being attempted should not be trusted, the security algorithm:
upon detecting that the scannable code on a packaging label has been scanned, determining, based on one or more preselected criterion, whether a transaction being attempted should not be trusted; and
if a determination is made that the transaction being attempted should not be trusted, causing the handheld device to notify a user of the handheld device that the transaction should not be trusted.

21. The blockchain system of claim 20, wherein said one or more preselected criterion are selected from the group comprising (1) whether or not the scannable code has been scanned multiple times, (2) locations at which multiple scans of the scannable code occurred, (3) dates and times when multiple scans of the scannable code occurred, (4) a length of time that has lapsed between a time when a most recent scan of the scannable code occurred and a time when the scannable code was previously scanned, and (5) a length of time that has lapsed between a date on which the most recent scan occurred and a date on which the item was created.

22. A handheld device being configured to authenticate items using a blockchain network, the handheld device comprising:
one or more processors configured to perform one or more algorithms that:
process a scannable code disposed on a packaging label of an item to be authenticated using the blockchain network to produce a data signal representing the scannable code;
decode the data signal representing the scannable code into a decoded data signal, the decoded data signal comprising a nonfungible token (NFT) associated with the item, the NFT being linked to the blockchain network;
process the decoded data signal to extract the NFT;
process the extracted NFT to obtain a unique identification (ID) associated with the item from the NFT;
forward the unique ID in an authentication request to one or more processors of the blockchain network to be processed by said one or more processors of the blockchain network to authenticate the item associated with the NFT;
if the said one or more processors of the blockchain network is able to authenticate the item, receiving an acknowledgement from the blockchain network that the item is authentic along with preselected data that was used to generate the NFT; and
displaying an indication on a display device of the handheld device that the item has been authenticated along with the preselected data.
